(19) United States
(12) Patent Application Publication
(10) Pub. No.: US 2012/0246919 A1
(43) Pub. Date: Oct. 4, 2012

(54) PHONE JACK COMPRESSION TOOL AND METHOD OF USE THEREOF

(75) Inventors: Wayne Evans, Oakland, ME (US); Noah Montena, Syracuse, NY (US)

(73) Assignee: JOHN MEZZALINGUA ASSOCIATES, INC., East Syracuse, NY (US)

(21) Appl. No.: 13/076,663

(22) Filed: Mar. 31, 2011

(51) Int. Cl. H01R 43/042

(52) U.S. Cl. 29/753

(57) ABSTRACT

Disclosed herein is a phone jack compression tool that includes a main body having a compression chamber that is configured for receiving an angled phone jack connector. The main body includes an opening under the compression chamber for accommodating the angled phone jack connector. The main body further includes a sliding body. The phone jack compression tool further includes a handle operably connected to the main body such that movement of the handle with respect to the main body causes the sliding body to move between an uncompressed position and a compressed position.

### FIELD OF TECHNOLOGY

The subject matter disclosed herein relates generally to the field of tools for terminating phone jack connectors to cable ends by compression. More particularly, this invention provides for a single tool for compressing various different types and sizes of phone jacks, and a method of use thereof.

### BACKGROUND

There are many types of audio and visual connectors, hereinafter referred to as “phone jacks,” that are used to connect with a variety of electronics. For example, phone jacks such as TRS (tip, ring, sleeve) connectors, TRRS (tip, ring, ring, sleeve) connectors, and TS (tip, sleeve) connectors are common audio connectors. Likewise, phono connectors such as RCA connectors exist for carrying both audio and visual signals. Furthermore, some of these phone jacks are right-angle connectors, or 135 degree connectors. With these angled connectors, the structure of the phone jack is such that the jack permanently extends at an angle (90 degrees or 135 degrees) from the terminated wire or cable.

Phone jack type connectors are commonly configured to be fastened to a wire or cable (terminated) by axially compressing the portion of the jack that the wire or cable is inserted into. However, due to the various geometries of the different types of connectors, a different tool is required to terminate each different type of phone jack. For example, a tool that is capable of terminating a right-angle phone jack connector will not be capable of accurately and effectively terminating a straight phone jack connector. Accordingly, a single tool that accommodates various different types of phone jacks, and a method of use thereof, would be well received in the art.

### BRIEF DESCRIPTION

According to one aspect, a phone jack compression tool comprises: a main body having a compression chamber that is configured for receiving an angled phone jack connector, the main body including an opening under the compression chamber for accommodating the angled phone jack connector, the main body further including a sliding body; and a handle operably connected to the main body such that movement of the handle with respect to the main body causes the sliding body to move between an uncompressed position and a compressed position.

According to another aspect, a phone jack compression tool comprises a main body having a compression chamber, the compression chamber comprising a first receiving channel configured to receive a male phone jack connector and a second receiving channel configured to receive a female phone jack connector; and a handle hingedly connected to the main body such that movement of the handle with respect to the main body compresses the compression chamber such that a received phone jack connector is compressed.

According to yet another aspect, a phone jack compression tool comprises: a main body having a compression means for compressing each of: a received right angle phone jack connector; a received 135 degree angle phone jack connector; a received straight-line male phone jack connector; and a received straight-line female phone jack connector; wherein the compressing of each connector comprises securing a wire or cable to the connector.

According to still another aspect, a method of compressing a cable connector to fixedly attach a cable to the cable connector comprises: providing a phone jack compression tool, the compression tool including: a main body having a compression chamber that is configured for receiving an angled phone jack connector, the main body having an opening on an under surface for accommodating the angled phone jack connector, the main body further including a sliding body; and a handle operably connected to the main body; moving the handle with respect to the main body; sliding the sliding body from an uncompressed position to a compressed position; and compressing the angled phone jack connector.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a perspective view of a phone jack compression tool in a spread apart position according to one embodiment;

FIG. 2 depicts a perspective view of the phone jack compression tool of FIG. 1 in a compressed position according to one embodiment;

FIG. 3 depicts a perspective view of the phone jack compression tool of FIGS. 1-2, after having received a straight-line male RCA connector according to one embodiment;

FIG. 4 depicts a perspective view of the phone jack compression tool of FIGS. 1-3, after having received a straight-line TRS connector according to one embodiment;

FIG. 5 depicts a perspective view of the phone jack compression tool of FIGS. 1-4, after having received a 90 degree TRS connector according to one embodiment;

FIG. 6 depicts a perspective view of the phone jack compression tool of FIGS. 1-5, after having received a 135 degree TRS connector according to one embodiment; and

FIG. 7 depicts a perspective view of the phone jack compression tool of FIGS. 1-6, after having received a female RCA connector according to one embodiment.

### DETAILED DESCRIPTION

A detailed description of the hereinafter described embodiments of the disclosed apparatus and method are presented herein by way of exemplification and not limitation with reference to the Figures.

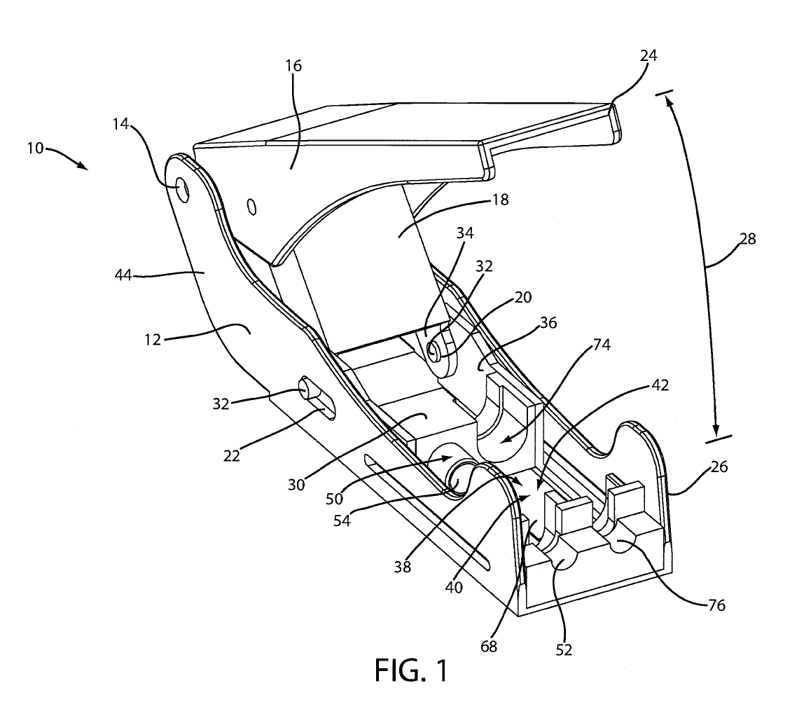

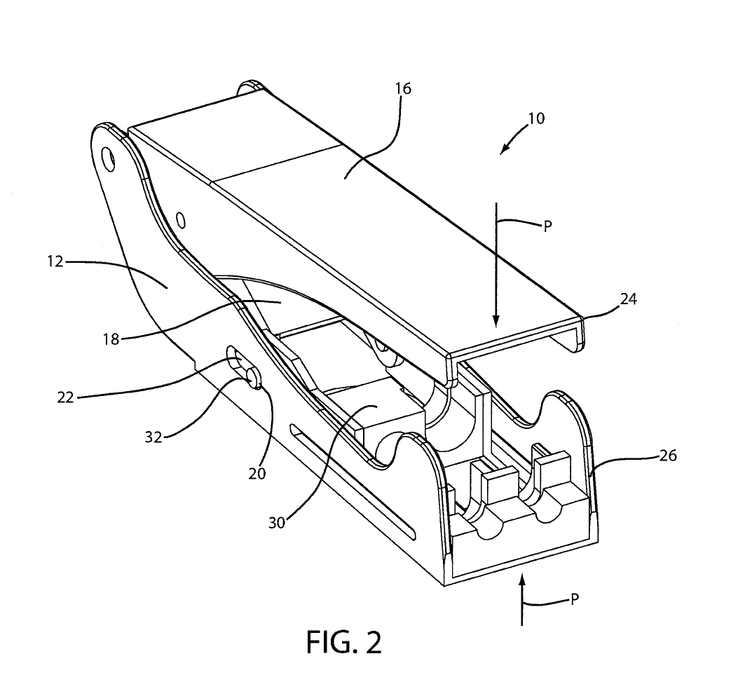

Referring firstly to FIGS. 1 and 2, a phone jack compression tool 10 is shown. The phone jack compression tool 10 includes a main body 12. It should be understood that the main body 12 may also be a base, foundation, bottom, support, or any other structure capable of housing the elements described herein after. Extending from a first hinge 14 at one end of the main body 12 is a handle 16. The first hinge 14 may also be any type of structural element that allows rotation of the handle 16 with respect to the main body 12. The first hinge 14 may, for example, comprise a pin or bolt extending through openings or holes in both the main body 12 and the handle 16 and fastened at both ends by knobs, nuts or heads. It should be understood that the handle 16 may be movably attached to the main body 12 by any number of devices or means such as a bar, catch, coupling, dowel, fastener, key, lag, latch, peg, pin, rivet, rod, screw, skewer, sliding bar, spike, staple or stud. Furthermore, the handle 16 may also be a grip, knob, lever or the like that is capable of rotation about the first hinge 14 with respect to the main body 12.

A lever 18 is connected to the handle 16 at a second hinge 20. The lever 18 may also be referred to as a beam, linkage, bar, connector or the like. Like the first hinge 14, the second hinge 20 may comprise a pin or bolt extending through openings or holes in the handle 16 and the lever 18 and fastened at both ends by knobs nuts, or other heads. The lever 18 may extend from the second hinge 20 to the main body 12 where the lever 18 is connected at slots 22.

Relative the first hinge 14, the handle 16 includes a distal end 24 and the main body 12 includes a distal end 26. Prior to compression, the main body 12 and the handle 16 are configured to remain in a spread-apart position where the distal ends 24, 26 are separated by a distance 28, shown in FIG. 1. The phone jack compression tool 10, and more particularly the lever 18, may be spring-loaded or otherwise tensioned to remain in this un-compressed and separated position. Alternately, the phone jack compression tool 10 may be tensioned to remain in a compressed position, and a user may be required to pull the handle 16 apart from the main body 12. Still further, there may be no tensioning of the handle 16 with respect to the main body 12.

When subjected to a compressive force P, the main body 12 and the handle 16 are configured to converge such that the distal ends 24, 26 meet, as shown in FIG. 2. Compression of the main body 12 and the handle 16 result in the lever 18 hingedly rotating with respect to the handle 16 about the second hinge 20 and slidably moving along the slots 22 from a first position A, shown in FIG. 1, to a second position B, shown in FIG. 2. The lever 18 is operably attached to a sliding body 30 that is located between the walls of the main body 12, such that movement of the lever 18 from the first position A to the second position B results in movement of the sliding body 30 closer to the distal end 26 of the main body 12.

In the embodiment depicted, the operable attachment of the lever 18 and the sliding body 30 is accomplished through two pins 32. The lever 18 includes two flanges 34 at the end that is operably connected to the sliding body, each of the flanges 34 including an opening through which the pins 32 are inserted. Similarly, each of the pins 32 extends through a side 36 of the sliding body 30 into the slots 22 of the main body 12. Each of the pins 32 is slidably locked into the slots 22 such that the compression of the main body 12 and the handle 16 results in a movement of the sliding body 30 along the slots 22. During this compressive motion, this embodiment allows for the lever 18 to rotate relative to the sliding body 30. It should also be understood that the two pins 32 may be replaced by a single pin or bolt extending through each of the openings of the sliding body 30, the lever 18 and the main body 12.

The compression of the phone jack compression tool 10 may be performed in a handheld manner by compressing both the handle 16 and the main body 12. Alternately, the handle 16 may be compressed while the phone jack compression tool 10 is resting on a surface, such as a table (not shown). Furthermore, there are many embodiments that are contemplated to accomplish this compressive motion of the sliding body 30 with respect to the distal end 26 of the main body 12, and the embodiment described is solely for exemplification and is not meant to be limiting.

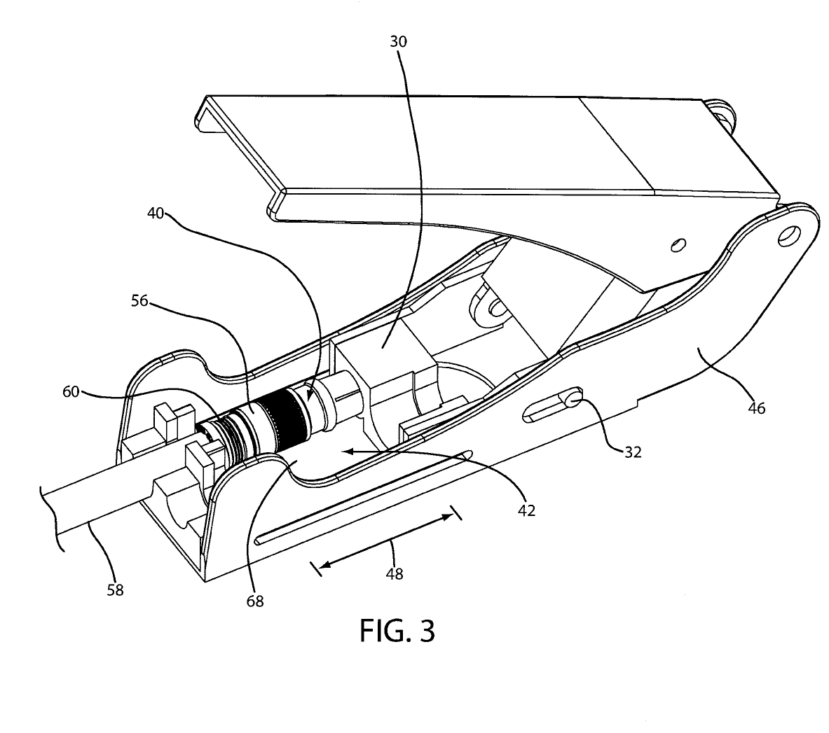

The main body 12 of the phone jack compression tool 10 includes a compression chamber 38 that is located between the sliding body 30 and the distal end 26 of the main body 12. The compression chamber 38 comprises a left receiving channel 40 and a right receiving channel 42 which are defined between a left side 44 and a right side 46 of the main body 12. In combination, the left receiving channel 40 and the right receiving channel 42 are configured to receive a plurality of compression phone jack type connectors (shown in FIGS. 3-7). Because a length 48 of the compression chamber 38 is defined by the sliding body 30, when the main body 12 and the handle 16 are compressed the compression chamber 38 is reduced in size. This motion of the sliding body 30 is thereby configured to compress any compression phone jack type connector that is located within the receiving channels 40, 42.

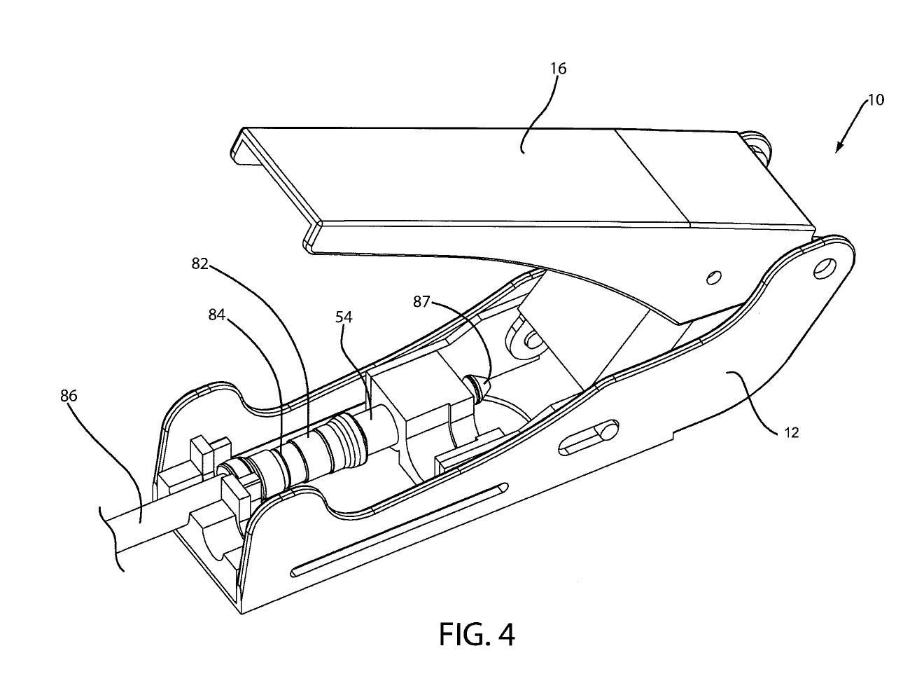

In the embodiment shown in the Figures, the left receiving channel 40 comprises a male phone jack acceptor 50 integrated into the left side of the sliding body 30 and a left cradle 52 integrated into the distal end 26 of the main body 12. Furthermore, in this embodiment the male phone jack acceptor 50 comprises a circular opening element 54. The circular opening element 54 may extend or protrude from the sliding body 30 in the direction of the distal end 26 of the main body 12. The opening of the circular opening element 54 may extend through the sliding body 30 in order to accept straight-line phone jack connectors, as described herein below and shown in FIG. 4.

Referring now to FIG. 3, the circular opening element 54 may be dimensioned to accept, obtain or otherwise receive a male RCA phone jack connector 56. The male RCA phone jack connector 56 may be any type of RCA phone jack connector 56 that is connectable to a wire or cable 58 via compression of a compression portion 60. The pin (not shown) of the male RCA phone jack connector 56 is configured to rest within the opening, bore, notch, gap or hole of the circular opening element 54. The sleeve of the male RCA phone jack connector 56 is configured to rest around the circumference of the circular opening element 54. It should be understood that the circular opening element 54 may be replaced with any type of male phone jack accepting element that is configured to accept, obtain or otherwise receive a male RCA phone jack connector.

Furthermore, the left cradles 52 may be capable of cradling or receiving, holding, or guiding the cable or wire 58 during the assembly of a connector to the wire. It should be understood that although a U-shaped cradle is depicted, other shapes and devices may be within the purview of the present invention. For example, the left cradle 52 may be a fastener, catch, clasp, grip, lock, snap, vice, clamp, hole, guide, opening, aperture, cavity, chamber, cleft, cut, dent, depression, dimple, dip, gap, keyhole, lacuna, notch, orifice, outlet, or passage. Whatever the embodiment, the left cradle 52 is aligned with the male phone jack acceptor 50.

Referring now to FIG. 4, the left receiving channel 40 may also be configured to receive a straight-line TRS connector 82. The straight line TRS connector 82 may have a compression portion 84 and a tip 87. In this embodiment, the jack of the straight line TRS connector 82 may fit within the opening or bore of the circular opening element 54 such that the tip 87 extends through the opening to the opposite side of the sliding body 30. Thus, the circular opening element 54 may stabilize the straight-line TRS connector 82 during compression of the compression portion 84 to a wire or cable 86.

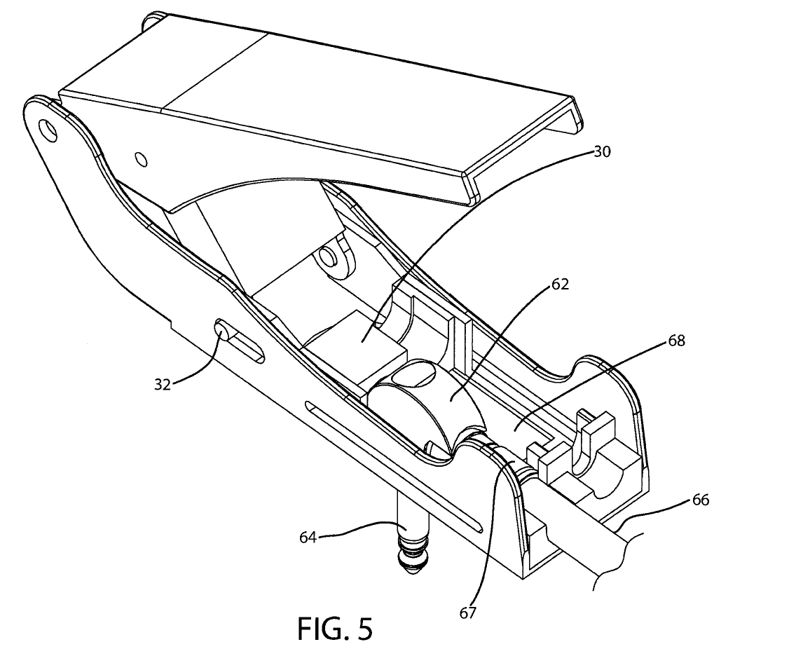

As shown in FIG. 5, the left receiving channel 40 may also be configured to receive a phone jack TRS style connector. For example, the left receiving channel 40 may be configured to receive a right angle TRS connector 62 with a jack 64 extending 90 degrees from a terminated wire 66. The right angle TRS connector 62 includes a compression portion 67. In order to accommodate the right angle TRS connector 62, the compression chamber 38 may include an opening 68 in the under surface of the main body 12 between the sliding body 30 and the distal end 26. Thus, the jack 64 extends under the main body 12 during compression of the right angle TRS connector 62 during compression. The opening 68 may be any type of opening, bore, hole, aperture, slot, slit, vent, window, and the like. The opening 68 may extend under the entirety of the compression chamber 38. Alternately, the opening 68 may be a smaller opening that is particularly sized to accept one or more jacks, such as the jack 64, of at least one angled connector. In this embodiment (not shown), the opening 68 may be particularly sized so that the jack 64 rests in the opening 68 such that the opening 68 secures and supports the jack 64 during compression.

Furthermore, the protruding circular opening element 54 may abut or otherwise be in contact with the right angle TRS connector 62 to help retain the connector 62 in the proper position within the compression chamber 38 during compression. In some embodiments, the right angle TRS connector 62 may include a bored portion or other physical feature that interacts with the male phone jack acceptor 50.

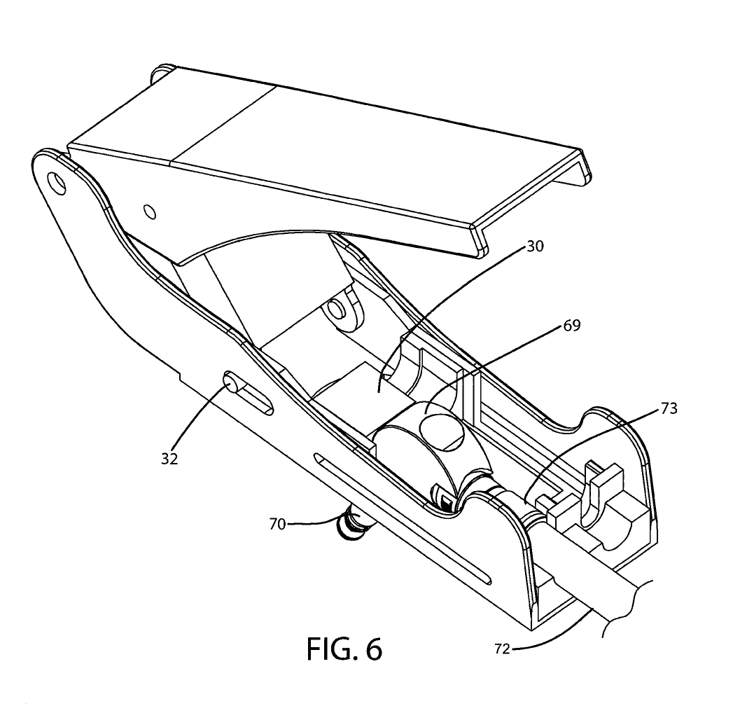

Like the right angle TRS connector 62, the left receiving channel 40 may also be configured to receive a 135 degree TRS connector 69 with a jack 70 extending 135 degrees from a terminated wire 72, as shown in FIG. 6. The 135 degree TRS connector 69 includes a compression portion 73. The jack 70 of the 135 degree TRS connector 69 extends out of the opening 68 in the under-surface of the main body 12, similar to the jack 64 of the right angle TRS connector 62. The 135 degree TRS connector 69 may also interact with the male phone jack acceptor 50 in a similar manner to the right angle TRS connector 62. In addition to the right angle TRS connector 62 and the 135 degree TRS connector 69, and the straight line TRS connector 82, it should be understood that the male phone jack acceptor 50 and the left receiving channel 40 may be configured to receive any type of compressible straight-line or angled phone jack style connector (not shown), or any variation thereof, such as a TRRS connector, a TR (tip, ring) connector, a TS connector or the like.

Referring back to FIGS. 1-2, the right receiving channel 42 of the phone jack compression tool 10 comprises a female phone jack acceptor 74 integrated into the sliding body 30 and a right cradle 76 integrated into the distal end 26 of the main body 12. It should be understood that the orientation of the left and right receiving channels 40, 42 is variable and that the embodiment depicted is exemplary but not limiting. For example, the left receiving channel 40 may be the female connector side while the right receiving channel 42 may be the male connector side. Whatever the arrangement, the left and right receiving channels 40, 42 are configured to retain and compress the variety of different types of phone jack type connectors described herein. Furthermore, the opening 68 in the under surface of the main body 12 may extend beneath the right receiving channel 42. Thus, the right receiving channel 42 may be configured to accept angled connectors in a similar manner to the right angled TRS connector 62 and the 135 degree TRS connector 68, as described herein above.

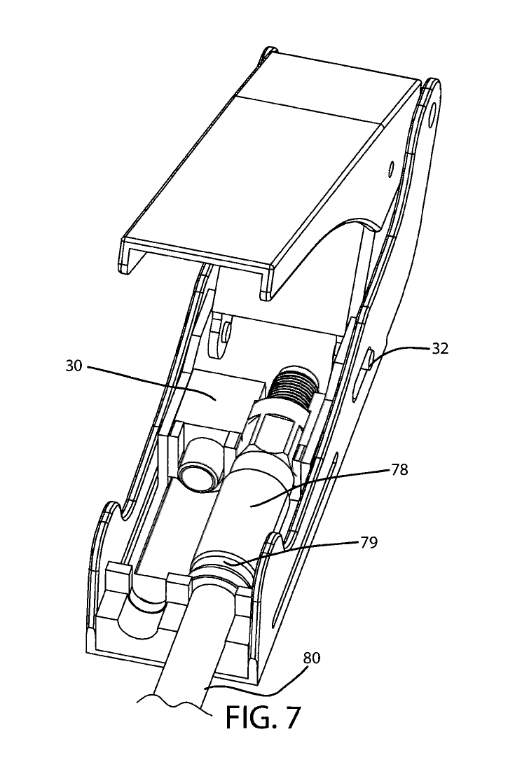

Referring now to FIG. 7, the female phone jack acceptor 74 is shown as a U-shaped channel located in the right side of the sliding body 30 that is capable of accepting, obtaining or otherwise receiving a female phone jack connector 78. The female phone jack connector 78 includes a compression portion 79. While FIG. 6 only depicts the female phone jack connector 78, other female connectors are contemplated. It should be understood that the right receiving channel 42, and the female phone jack acceptor 74 may be configured to accept, obtain or otherwise receive any female phone jack type connector. Furthermore, while the female phone jack acceptor 74 is only shown as a U-shaped channel, any embodiment that is capable of receiving a variety of female phone jack type connectors is contemplated.

The right cradle 76 may be capable of cradling or receiving, holding, or guiding a cable or wire 80 during the assembly of the female phone jack connector 78 to the wire 80. It should be understood that although a U-shaped cradle is depicted, other shapes and devices may be within the purview of the present invention. For example, the left cradle 52 may be a fastener, catch, clasp, grip, lock, snap, vice, clamp, hole, guide, opening, aperture, cavity, chamber, cleft, cut, dent, depression, dimple, dip, gap, keyhole, lacuna, notch, orifice, outlet, or passage. Whatever the embodiment, the right cradle 76 is aligned with the female phone jack acceptor 74.

Compression of the connectors using the phone jack compression tool 10 may be performed using other means than those exemplified in the Figures. For example, the phone jack compression tool 10 may be compressed using a handle with two bars or beams that are separate from the main body 12 and pivotal about a hinge. The compression of these two beams may cause the compression chamber 38 to compress. Further, compression may be initiated or activated electrically, rather than mechanically. A user may, for example, simply need to press an activation or initiation button to compress a connector using the phone jack compression tool 10.

It should be understood that the components of the phone jack compression tool 10 may be made out of any structurally rigid material, such as steel or other metal, plastic, composites, polymers or the like. Furthermore, the main body 12 and/or handle 16 may be made out of panels that may be assembled to form the phone jack compression tool 10. It should be understood that the phone jack compression tool 10 may be stamped, cut, shaped, bored, turned, milled, finished, machined, forged, cold worked, heat treated or assembled with conventional fasteners such as stamps, welds, adhesive, rivets, pins, screws, nails and the like. If made of plastic, polymer or composite, the phone jack compression tool 10 may be molded and either adhered or glued, welded or mechanically or chemically fastened together. The phone jack compression tool 10 is not limited to any specific material or manufacturing process as long as it is capable of performing the above described compression for a useful life of the phone jack compression tool 10. Moreover, the handle 16 may comprise a material has a high coefficient of friction with the skin, in order to increase grippage during compression. Furthermore, the handle 16 may have an ergonomic design for the ease of handling and comfort during compression by a user.

Furthermore, an embodiment contemplated includes a method of compressing a cable connector to fixedly attach a cable to the cable connector. The method may first include providing a phone jack compression tool, such as any of the described embodiments of the compression tool 10. The compression tool may include a main body, such as the main body 12, having a compression chamber, such as any of the described embodiments of the compression chamber 38. The compression chamber may be configured for receiving an angled phone jack connector, such as any of the described embodiments of the right angle TRS connector 62 or the 135 degree TRS connector 69. The main body may have an opening on an under surface, such as any of the described embodiments of the opening 68, for accommodating the angled phone jack connector. The main body may further include a sliding body, such as any of the described embodiments of the sliding body 30. Finally a handle, such as any of the described embodiments of the handle 16, may be operably connected to the main body. The method may further include moving the handle with respect to the main body. Moreover, the method may include sliding the sliding body from an uncompressed position to a compressed position. The method may thus include compressing the angled phone jack connector.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A phone jack compression tool comprising:
a main body having a compression chamber that is configured for receiving an angled phone jack connector, the main body having an opening on an under surface for accommodating the angled phone jack connector, the main body further including a sliding body; and
a handle operably connected to the main body such that movement of the handle with respect to the main body causes the sliding body to move between an uncompressed position and a compressed position.

2. The phone jack compression tool of claim 1, wherein the compression chamber further comprises a first receiving channel configured to receive a male phone jack connector and a second receiving channel configured to receive a female phone jack connector.

3. The phone jack compression tool of claim 2, wherein the first receiving channel is configured to receive:
a received right angle phone jack connector;
a received 135 degree angle phone jack connector; and
a received straight-line male phone jack connector.

4. The phone jack compression tool of claim 1, wherein the sliding body includes a male phone jack acceptor and a female phone jack acceptor.

5. The phone jack compression tool of claim 4, wherein the male phone jack acceptor includes a circular opening element, wherein a pin of a straight-line male RCA connector is configured to be received within the circular opening element, and a sleeve of the straight-line male RCA connector is configured to rest around the circular opening element.

6. The phone jack compression tool of claim 4, wherein the female phone jack acceptor includes a U-shaped channel.

7. The phone jack compression tool of claim 4, wherein the compression chamber is bounded between the sliding body, and a distal end of the main body, and wherein the distal end of the main body includes a first cradle and a second cradle that are each configured to receive a wire.

8. The phone jack compression tool of claim 1, wherein the main body is connected to the handle at a hinge and wherein the main body includes a distal end relative the hinge, and the handle includes a distal end relative the hinge, wherein the main body and the handle are configured to be moved between the uncompressed position, where the distal end of the main body and the distal end of the handle are spread apart, and compressed position, where the distal end of the main body and the distal end of the handle are converged.

9. The phone jack compression tool of claim 8, further comprising a lever that is hingedly connected between the main body and the handle, wherein the lever is in operable communication with the sliding body such that the lever is configured to move the sliding body closer to the distal end of the main body when the main body and the handle are compressed.

10. A phone jack compression tool comprising:
a main body having a compression chamber, the compression chamber comprising a first receiving channel configured to receive a male phone jack connector and a second receiving channel configured to receive a female phone jack connector; and
a handle movably connected to the main body such that movement of the handle with respect to the main body compresses the compression chamber such that a received phone jack connector is compressed.

11. The phone jack compression tool of claim 10, the main body further comprising an opening under the compression chamber for accommodating the angled phone jack connector.

12. The phone jack compression tool of claim 10, wherein the first receiving channel is configured to receive:
a received right angle phone jack connector;
a received 135 degree angle phone jack connector; and
a received straight-line male phone jack connector.

13. The phone jack compression tool of claim 10, wherein the compression chamber is defined between a sliding body and a distal end of the main body.

14. The phone jack compression tool of claim 13, wherein movement of the handle with respect to the main body causes the sliding body to compress the compression chamber.

15. The phone jack compression tool of claim 13, wherein the sliding body includes a male phone jack acceptor and a female phone jack acceptor.

16. The phone jack compression tool of claim 15, wherein the male phone jack acceptor includes a circular opening element, wherein a pin of a straight-line male RCA connector is configured to be received within the circular opening element, and a sleeve of the straight-line male RCA connector is configured to rest around the circular opening element.

17. The phone jack compression tool of claim 13, wherein the female phone jack acceptor includes a U-shaped channel.

18. The phone jack compression tool of claim 13, wherein the distal end of the main body includes a first cradle and a second cradle that are each configured to receive a wire.

19. The phone jack compression tool of claim 10, wherein the main body is connected to the handle at a hinge and wherein the main body includes a distal end relative the hinge, and the handle includes a distal end relative the hinge, wherein the main body and the handle are configured to be moved between the uncompressed position, where the distal end of the main body and the distal end of the handle are spread apart, and compressed position, where the distal end of the main body and the distal end of the handle are converged, wherein movement from the uncompressed position to the compressed position compresses the compression chamber.

20. A phone jack compression tool comprising:
a main body having a compression means for compressing each of:
a received right angle phone jack connector;
a received 135 degree angle phone jack connector;
a received straight-line male phone jack connector; and
a received straight-line female phone jack connector;
wherein the compressing of each connector comprises securing a cable to the connector.

21. A method of compressing a cable connector to fixedly attach a cable to the cable connector, the method comprising:
providing a phone jack compression tool, the compression tool including:
a main body having a compression chamber that is configured for receiving an angled phone jack connector, the main body having an opening on an under surface for accommodating the angled phone jack connector, the main body further including a sliding body; and
a handle operably connected to the main body;
moving the handle with respect to the main body;
sliding the sliding body from an uncompressed position to a compressed position; and
compressing the angled phone jack connector.
